(19) United States
(12) Patent Application Publication
(10) Pub. No.: US 2025/0369254 A1
(43) Pub. Date: Dec. 4, 2025

(54) TAMPER RESISTANT LOCK SYSTEM

(71) Applicant: Securitech Group, Inc., Maspeth, NY (US)

(72) Inventors: Krzysztof F. Marciniec, Glendale, NY (US); David Mate, Maspeth, NY (US)

(73) Assignee: Securitech Group, Inc., Maspeth, NY (US)

(21) Appl. No.: 19/220,663

(22) Filed: May 28, 2025

Related U.S. Application Data
(60) Provisional application No. 63/653,331, filed on May 30, 2024.

(51) Int. Cl. E05B 17/20; E05B 63/08

(52) U.S. Cl. CPC E05B 17/2092; E05B 2017/2096; E05B 63/08

(57) ABSTRACT

A tamper resistant lock system is provided. The lock system may include a lock body with a bolt assembly configured to move between engaged and disengaged position. The lock system may also include a lock trim assembly configured to actuate the bolt assembly. The lock body may include a spindle cam latch assembly configured to prevent rotation of a spindle cam of the bolt assembly if the lock trim assembly is removed from the lock body. The lock body may include a spindle cam shutter assembly configured to block access to a spindle cam of the bolt assembly if the lock trim assembly is removed from the lock body.

### CROSS REFERENCE TO RELATED APPLICATIONS

This application claims the benefit under 35 U.S.C. § 119(e) to U.S. Provisional Application Ser. No. 63/653,331, filed May 30, 2024, entitled “HUB BLOCKER,” which is incorporated herein by reference in their entirety.

### FIELD

The field is related to door lock systems.

### BACKGROUND

Door lock systems generally include lock bodies and lock trim assemblies. The lock bodies may include bolt assemblies with a deadbolt and/or latch configured to move between engaged and disengaged position(s). In the engaged position, the deadbolt/latch is generally received into a pocket in the door jamb to prevent opening of the door. In the disengaged position, the deadbolt/latch is retracted into the lock body, allowing the door to be opened.

The deadbolt and/or latch is moved to the disengaged positions by actuation of a lock trim actuator (handle, knob,) of a lock trim assembly. The lock trim assembly generally includes a lock spindle operatively connected to the lock trim, such that rotation of the lock trim actuator about a lock axis rotates the lock spindle about the lock axis.

The lock spindle is operatively connected to components of the deadbolt assembly and/or latch assembly, such that the deadbolt and/or latch is moved to the retracted position when the lock spindle is rotated about the lock axis. The deadbolt assembly and/or latch assembly generally includes at least one spindle cam configured to engaged with the lock spindle, such that the spindle cam rotates with the lock spindle, and a transmission unit which engages with the spindle cam and the deadbolt/door latch so that the deadbolt/door latch retracts when the spindle cam rotates.

Door lock systems are generally locked by preventing rotation of the lock spindle. This may be accomplished by preventing rotation of the lock trim actuator, or by decoupling the lock spindle from the lock trim actuator, such that rotating the lock trim actuator does not rotate the lock spindle.

### SUMMARY

According to some aspects, a lock body is provided, the lock body comprising a bolt assembly and a spindle cam latch assembly. The bolt assembly comprises a spindle cam configured to engage with a lock spindle of a lock trim assembly, such that rotating the lock spindle about a lock axis rotates the spindle cam about the lock axis. The spindle cam latch assembly comprises a cam latch configured to move between an engaged position, where the cam latch engages with the bolt assembly to prevent rotation of the spindle cam about the lock axis, and a disengaged position, and a biasing mechanism configured to bias the cam latch towards the engaged position. The cam latch is configured to selectively engage with a projection extending from the lock trim assembly, such that when the lock trim assembly is engaged with the lock body, the projection extends into the lock body and moves the cam latch to the disengaged position, and when the lock trim assembly is disengaged from the lock body, the projection is removed from the lock body and the cam latch is moved to the engaged position by the biasing mechanism.

According to some aspects, a door lock system is provided, the door lock system comprising a lock trim assembly and a lock body. The lock trim assembly comprises a lock trim actuator and a lock spindle configured to rotate about a lock axis, and a projection extending from the lock trim assembly. The lock body is configured to selectively engage with the lock trim assembly. The lock body comprises a bolt assembly comprising a spindle cam configured to engage with the lock spindle; such that rotating the lock spindle about the lock axis rotates the spindle cam about the lock axis, and a spindle cam latch assembly comprising a cam latch configured to move between an engaged position, where the cam latch engages with the latch assembly to prevent rotation of the spindle cam about the lock axis, and a disengaged position, and a biasing mechanism configured to bias the cam latch in the engaged position. The cam latch is configured to selectively engage with the projection extending from the lock trim assembly, such that when the lock trim assembly is engaged with the lock body, the projection extends into the lock body and moves the cam latch to the disengaged position, and when the lock trim assembly is disengaged from the lock body, the projection is removed from the lock body and the cam latch is moved to the engaged position by the biasing mechanism.

According to some aspects, a lock body is provided, the lock body comprising a bolt assembly comprising a spindle cam configured to engage with a lock spindle of a lock trim assembly, such that rotating the lock spindle about a lock axis rotates the spindle cam about the lock axis, and a spindle cam shutter assembly. The spindle cam shutter assembly comprises a cover plate configured to move between a cover plate engaged position and a cover plate disengaged position, wherein the cover plate is configured to cover the spindle cam in the cover plate engaged position, and a blocker configured move between a blocker engaged position and a blocker disengaged position, wherein the blocker is configured to hold the cover plate in the cover plate engaged position when the blocker is in the blocker engaged position. The cover plate is configured to be held in the cover plate disengaged position by a portion of the lock trim assembly, such that when the lock trim assembly is disengaged from the lock body, the cover plate moves to the cover plate engaged position.

According to some aspects, a door lock system is provided, the door lock system comprising a lock trim assembly and a lock body. The lock trim assembly comprises a lock spindle configured to rotate about a lock axis. The lock body is configured to selectively engage with the lock trim assembly and comprises a bolt assembly and a spindle cam shutter assembly. The bolt assembly comprises a spindle cam configured to engage with the lock spindle, such that rotating the lock spindle about the lock axis rotates the spindle cam about the lock axis. The spindle cam shutter assembly comprises a cover plate configured move between a cover plate engaged position and a cover plate disengaged position, wherein the cover plate is configured to cover the spindle cam in the cover plate engaged position, and a blocker configured move between a blocker engaged position and a blocker disengaged position, wherein the blocker is configured to hold the cover plate in the cover plate engaged position when the blocker is in the blocker engaged position. The cover plate is configured to be held in the cover plate disengaged position by a portion of the lock trim assembly, such that when the lock trim assembly is disengaged from the lock body, the cover plate moves to the cover plate engaged position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a partially exploded perspective view of a door lock system according to an embodiment;

FIG. 2 shows an exploded perspective view of a lock body of the door lock system of FIG. 1;

FIG. 3 shows a side view of a lock body of the door lock system of FIG. 1 with a deadbolt assembly in an engaged position;

FIG. 4 shows a side view of a lock body of the door lock system of FIG. 1 with a deadbolt assembly in a disengaged position;

FIG. 5 shows a side view of a lock body of the door lock system of FIG. 1 with a cam latch assembly in an engaged position;

FIG. 6A shows a schematic view of a lock body of a door lock system with a cam latch assembly in a disengaged position according to another embodiment;

FIG. 6B shows a schematic representation of the lock body of FIG. 6A with the cam latch assembly in an engaged position;

FIG. 7 shows a perspective view of a lock body of a door lock system according to yet another embodiment;

FIG. 8 shows a side view of the lock body of FIG. 7 with a cam blocker assembly in a disengaged position;

FIG. 9 shows a side view of the lock body of FIG. 7 with a cam blocker assembly in an engaged position;

FIG. 10 shows a side view of the lock body of FIG. 7 with a cam blocker assembly partially between the engaged and disengaged positions;

FIG. 11A shows a schematic view of a lock body of a door lock system with a cam blocker assembly in a disengaged position according to still another embodiment; and

FIG. 11B shows a schematic representation of the lock body of FIG. 10A with the cam blocker assembly in an engaged position.

FIG. 12 shows a side view of a lock body of a door lock system according to still another embodiment.

### DETAILED DESCRIPTION

As discussed above, door lock systems may include lock bodies with bolt assemblies configured to hold a door closed, and lock trim assemblies configured to actuate the bolt assemblies. The bolt assemblies may include any suitable bolts, such as deadbolts or latches. Door lock systems are generally locked by preventing rotation of the lock spindle, such as by preventing rotation of the lock trim, or by decoupling the lock spindle from the lock trim, such that rotating the lock trim actuator does not rotate the lock spindle.

However, locking a door lock system by preventing rotation of the lock spindle may make the lock susceptible to forced entry. If an intruder can forcibly remove the lock trim assembly (e.g. by drilling out fasteners, prying the lock trim assembly away, cutting the lock trim assembly away, etc.), a spindle cam of the bolt assembly will be accessible to the intruder. The intruder may then simply insert a rod (e.g. a screwdriver) into the spindle cam and rotate the rod to actuate the spindle cam, retracting the latch/deadbolt.

The inventors have therefore recognized an advantage to preventing retraction of the deadbolt/latch when a lock trim assembly is removed from the lock body. Accordingly, aspects disclosed herein are directed to arrangements for preventing actuation of the spindle cam.

In some embodiments, the lock body may include a cam latch assembly that is deployed to prevent spindle cam rotation. The cam latch assembly may include a cam latch configured to be in a disengaged position when a lock trim assembly is engaged with the lock body, and may move to an engaged position when the lock trim assembly is disengaged from the lock body. In the engaged position the cam latch may engage with the spindle cam and prevent rotation of the spindle cam about the lock axis.

In some embodiments, the lock trim assembly includes a projection extending from the lock trim assembly. The projection may be configured to extend into the lock body and contact the cam latch to move the cam latch to the disengaged position when the lock trim assembly is attached to the lock body. When the lock trim assembly is removed from the lock body, the projection may be removed from the lock body and no longer contact the cam latch, allowing the cam latch to be moved to the engaged position. In some embodiments, a biasing mechanism biases the cam latch to the engaged position when the projection is removed.

In some embodiments, the lock body may include a spindle cam shutter assembly. The spindle cam shutter assembly may include a cover plate configured to be in a disengaged position when a lock trim assembly is engaged with the lock body, and may move to an engaged position when the lock trim assembly is disengaged from the lock body. In the engaged position, the cover plate may cover the spindle cam so as to prevent external access to the spindle cam. In some embodiments, the cover plate may be supported in the disengaged position via a projection extending from the lock trim assembly and into the lock body when the lock trim assembly is engaged with the lock body. When the lock trim assembly is disengaged from the lock body, the projection may be removed from the lock body, and may no longer support the cover plate, allowing the cover plate to move to the engaged position. In some embodiments, a portion of the lock spindle of the lock trim assembly is configured to support the cover plate in the disengaged position. When the lock trim assembly is disengaged from the lock body, the lock spindle may be removed from the lock body, and may no longer support the cover plate, allowing the cover plate to move to the engaged position. In some embodiments, the portion of the lock spindle which supports the cover plate in the disengaged position includes a rounded cross-sectional profile. In some embodiments the cover plate may move to the engaged position via gravity.

In some embodiments, the spindle cam shutter assembly may include a blocker configured to move to an engaged position with the cover plate and to hold the cover plate in the engaged position to prevent an intruder from jimmying the cover plate to the disengaged position to gain access to the spindle cam.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

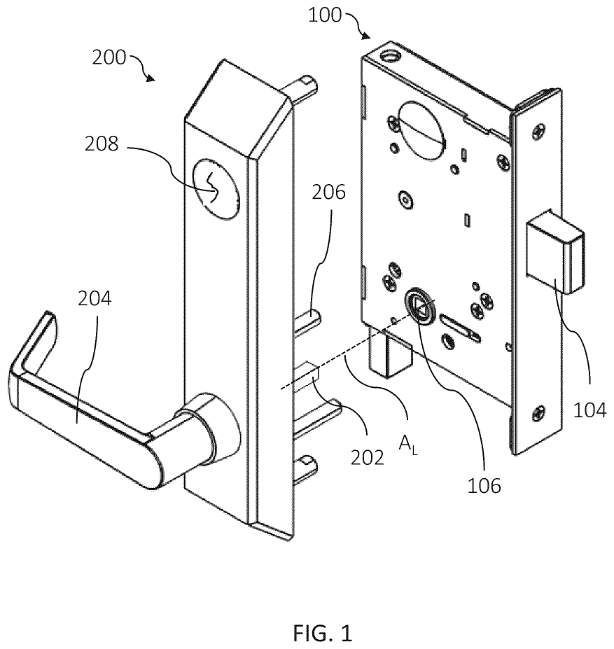

FIG. 1 shows a partially exploded perspective view of a lock system with lock body 100 and lock trim assembly 200.

Lock trim assembly 200 may be configured to be attached to a side of a door (e.g. an exterior side or an interior side). The lock trim assembly 200 may include lock spindle 202 and lock trim actuator 204. Lock spindle 202 and lock trim actuator 204 may be operatively connected, such that applying an external torque to the lock trim actuator 204 (e.g. by grasping and rotating the lock trim actuator) rotates the lock spindle 202 about lock axis A_{L}. Lock spindle 202 may be configured to engage with spindle cam 106 of a deadbolt assembly 102 in order to actuate a deadbolt 104 of the deadbolt assembly 102, as discussed further below. While lock trim actuator 204 is shown as a handle in FIG. 1, any suitable lock trim actuator is contemplated, such as a knob or a motor.

In some embodiments, lock trim assembly 200 may include a locking mechanism 208 configured to move between a locked position and an unlocked position. In the locked position, the locking mechanism may prevent activation of the deadbolt 104. This may be accomplished via any suitable locking mechanism, such as by prevention of rotation of the lock trim actuator 204 about the lock axis A_{L}, thereby preventing rotation of the lock spindle 202 about the lock axis A, or by decoupling the lock spindle 202 from the lock trim actuator 204, such that rotation of the lock trim actuator 204 about the lock axis A_{L} does not rotate the lock spindle about the lock axis. Such suitable locking mechanisms may include a lock cylinder, an electromechanical lock (e.g. a lock actuated via biometrics, passcodes, RFID, etc.), or any other conventional locking mechanism.

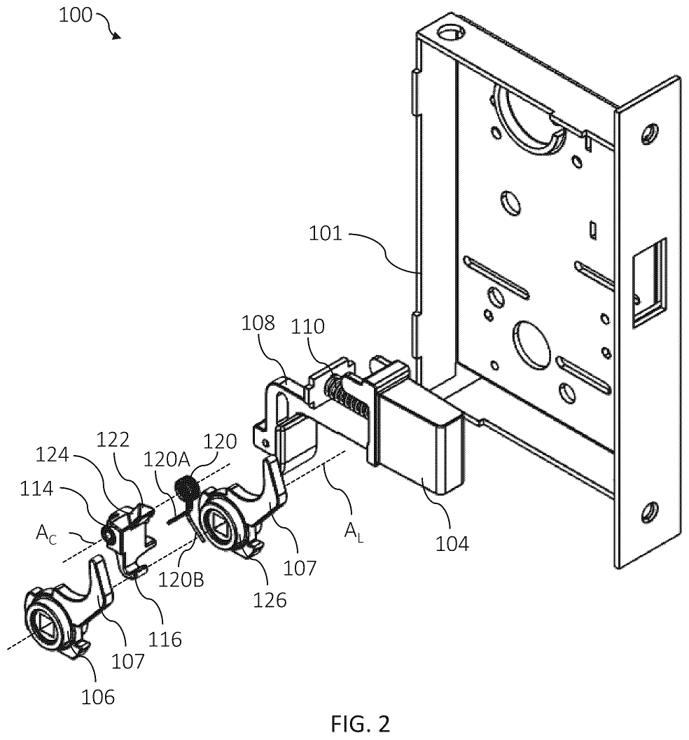

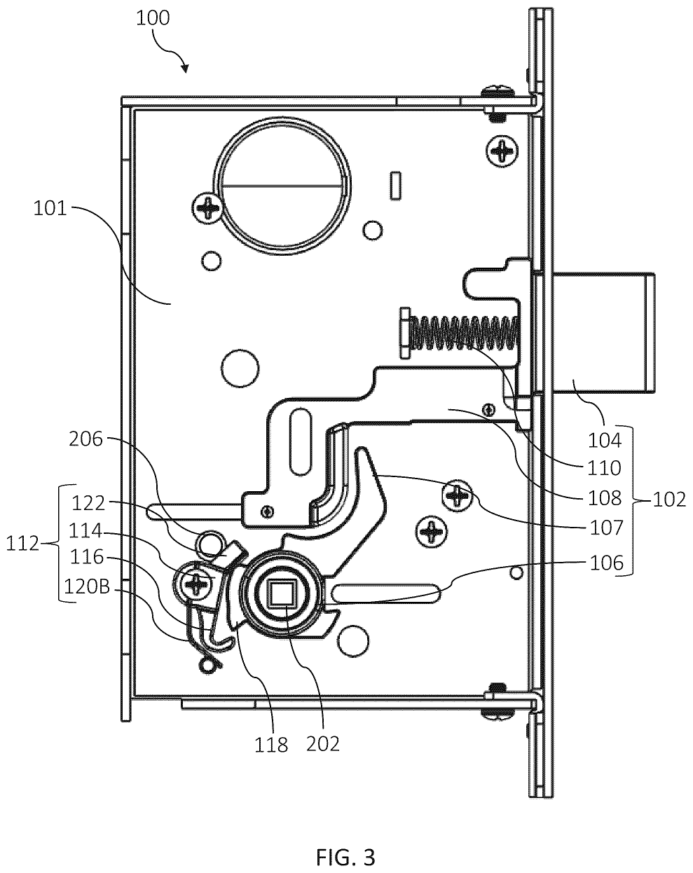

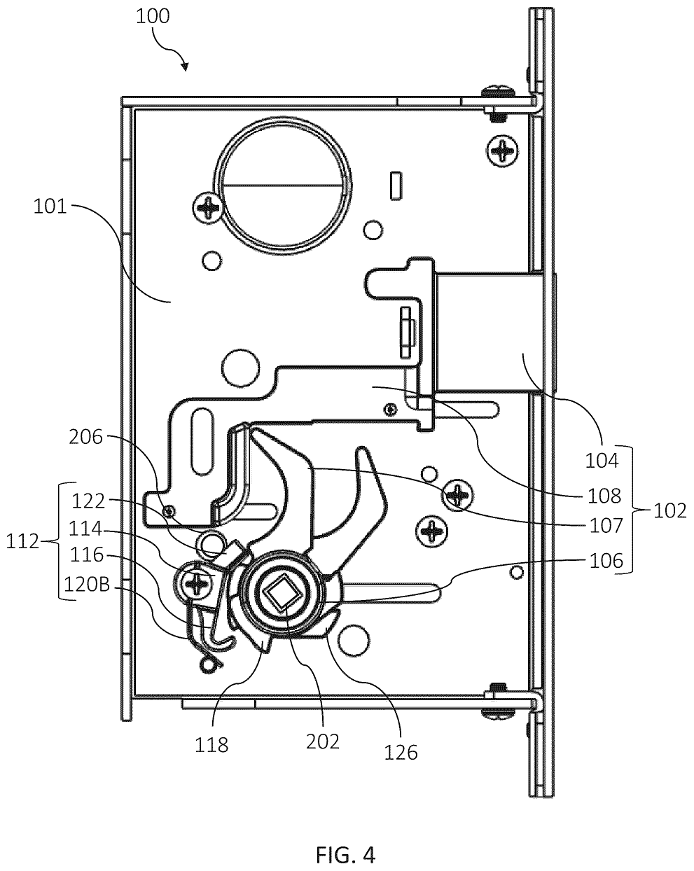

FIG. 2 shows an exploded perspective view of a lock body 100 of a door lock system. FIGS. 3 and 4 show a side view of lock body 100 with a deadbolt in engaged and disengaged positions, respectively.

As mentioned above, the lock spindle 202 may be operatively connected to a deadbolt assembly 102 of the lock body 100, such that actuating the lock trim actuator 204 between an engaged position and a disengaged position moves the deadbolt 104 between an engaged position, where the deadbolt 104 is received into a pocket of a door jamb to prevent opening of the door (as shown in FIG. 3), and a disengaged position, where the deadbolt 104 is retracted into the lock body 100 to allow the door to be opened (as shown in FIG. 4).

Deadbolt assembly 102 may include a spindle cam 106 configured to engage with lock spindle 202, such that spindle cam 106 rotates about lock axis AL in a first direction (e.g. counter-clockwise in FIG. 4) from the engaged position to the disengaged position as the lock spindle 202 rotates about the lock axis AL in the first direction. As spindle cam 106 rotates, a cam arm 107 of the spindle cam may contact transmission unit 108, moving the transmission unit from the engaged position to the disengaged position. The transmission unit 108 is operatively connected to the deadbolt 104, such that the deadbolt 104 moves from the engaged position to the disengaged position as the transmission unit 108 moves to the disengaged position.

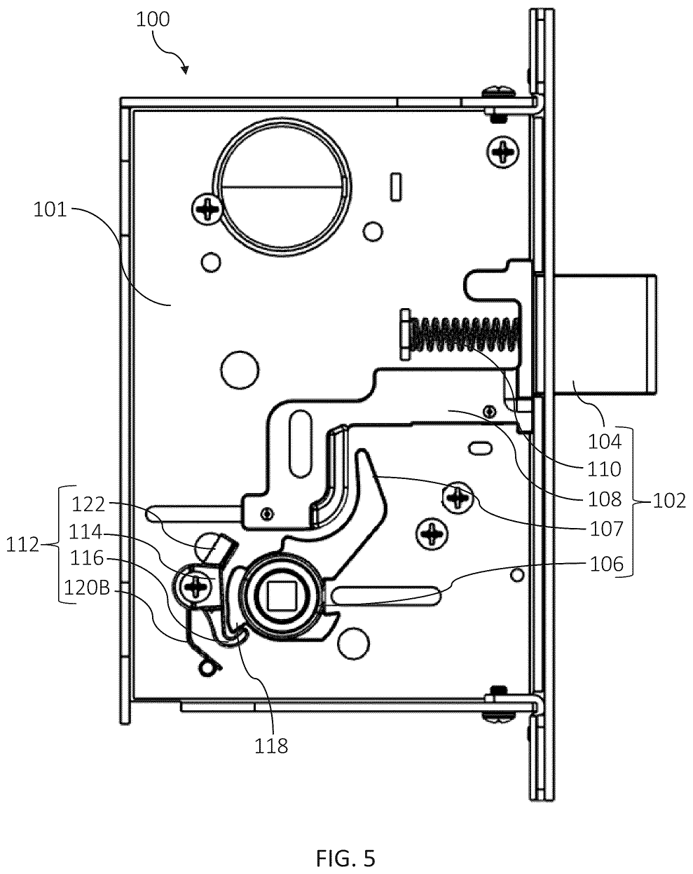

In some embodiments, cam arm 107 is configured to only push the deadbolt 104 to the disengaged position, such that the deadbolt 104 does not return to the engaged position when spindle cam 106 is returned to the engaged position. The deadbolt 104 may be held in the disengaged position via a separate trigger mechanism (not shown). Actuation of the trigger mechanism may release the deadbolt and may allow biasing mechanism 110 to bias the deadbolt 104 to the engaged position. The trigger mechanism may be configured to be actuated via contact between the trigger mechanism and a portion of the door jamb. Such a deadbolt assembly is disclosed in U.S. Pat. No. 11,702,864, which is incorporated by reference herein. FIG. 5 shows a side view of lock body 100 with a cam latch assembly in an engaged position. As discussed above, the inventors have recognized that it may be desirable to prevent rotation of the spindle cam 106 about lock axis A_{L}. when the lock trim assembly 200 is removed from the lock body 100, in order to prevent an intruder from being about to actuate the spindle cam 106 and retract the deadbolt 104 after forcibly removing the lock trim assembly 200. The lock body 100 may therefore include a spindle cam latching assembly 112 configured to prevent rotation of the spindle cam 106 when the lock trim assembly 200 is removed. The spindle cam latching assembly may include a cam latch 114 configured to move between an engaged position and a disengaged position. In some embodiments, as seen in FIGS. 2-5, the cam latch 114 may be configured to rotate about an axis Ac between the disengaged and engaged positions. In the disengaged position, as seen in FIG. 3, the cam latch 114 may be disengaged from any portion of the deadbolt assembly 102. This allows each component of the deadbolt assembly 102 to move between engaged and disengaged positions when a torque is applied to the spindle cam 106 via lock spindle 202, and allows the deadbolt 104 to be retracted, as seen in FIG. 4.

In the engaged position, the cam latch 114 may engage with the spindle cam 106, the transmission unit 108, or the deadbolt 104 and prevent movement of any of these components of the deadbolt assembly. For instance, as seen in FIG. 5, a hook portion 116 of cam latch 114 may be configured to interlock with a tab 118 on the spindle cam 106. When the hook portion 116 is interlocked with tab 118, a torque applied to the spindle cam 106 to rotate the spindle cam in the first direction (e.g. the counterclockwise direction in FIG. 5) will be prevented from rotating the spindle cam 106 in the first direction, thus preventing the arm 107 from moving the transmission unit 108 to the disengaged position, and preventing the deadbolt 104 from being retracted.

In some embodiments, the cam latch 114 may be biased towards the engaged position via biasing mechanism 120. In some embodiments, biasing mechanism 120 may be a torsion spring, with spring legs 120A and 120B. Spring leg 120A may be configured to contact a stationary portion of the lock body 100, while spring leg 100B may be configured to contact a portion of the cam latch 114. The torsion spring's stiffness may cause the legs 120A and 120B to extend away from each other, biasing the cam latch 114 to the engaged position.

In some embodiments, the lock trim assembly 200 may include a projection 206 configured to extend into the lock body 100 when the lock trim assembly 200 is attached to the lock body 100, and to be removed from the lock body 100 when the lock trim assembly 200 is removed from the lock body 100. When projection 206 extends into the lock body, projection 206 may be configured to contact the cam latch 114 and hold the cam latch 114 in the disengaged position. For instance, as seen in FIG. 4, the projection 206 may contact lever arm 122 of the cam latch 114. Lever arm 122 may include a slanted camming surface 124, such that when the slanted camming surface 124 is contacted by projection 206 as projection 206 is being inserted into the lock body 100, the projection 206 applies a force to lever arm 122 perpendicular to the direction of travel of the projection 206. This perpendicular force creates a torque on the cam latch 114 through the lever arm and rotates the cam latch 114 about the axis of rotation A_{C} to the disengaged position. When the lock trim assembly is removed from the lock body 100, the projection 206 may be removed from the lock body 100. This allows the biasing mechanism 120 to bias the cam latch 114 into the engaged position, preventing rotation of the spindle cam 106 and operation of the deadbolt assembly 102 from the side of the door the lock trim assembly 200 was removed from. In some embodiments, the projection 206 extends from the lock trim assembly 200 approximately parallel to the lock spindle 202. In some embodiments, the projection 206 includes a camming surface configured to correspond to camming surface 124 of lever arm 122. In some embodiments, projection 206 is a support post of the lock trim assembly 200 configured to allow the lock trim assembly 200 to be secured to the door and to corresponding lock trim assembly on the other side of the door.

In some embodiments, it may be desirable to allow the deadbolt assembly 102 to be actuated from an opposite side of the door (e.g. the unsecured side/interior side) even if the lock trim assembly 200 has been removed. The lock body 100 may therefore include a second spindle cam 126 configured to engage with a lock spindle of a corresponding lock trim assembly attached to the opposite side of the door. Second spindle cam 126 may be configured to rotate about lock axis A_{L} between engaged and disengaged positions independent of spindle cam 106. When second spindle cam 126 rotates to the disengaged position, an arm 107 of second spindle cam 126 may contact the transmission unit 108 and unlatch the deadbolt 104. Because second spindle cam 126 may rotate independent of spindle cam 106, the deadbolt assembly 102 may still be actuated from the opposite side of the door even if the spindle cam 106 is prevented from rotating by cam latch assembly 112. In some embodiments, it is contemplated that the lock body 100 may include a second cam latch assembly configured to engage only with the second spindle cam 126. In this manner, removing the lock trim assembly from either side of the door lock system may prevent actuation of the deadbolt assembly 102 from that side of the door, while still allowing users on the other side of the door to open the door.

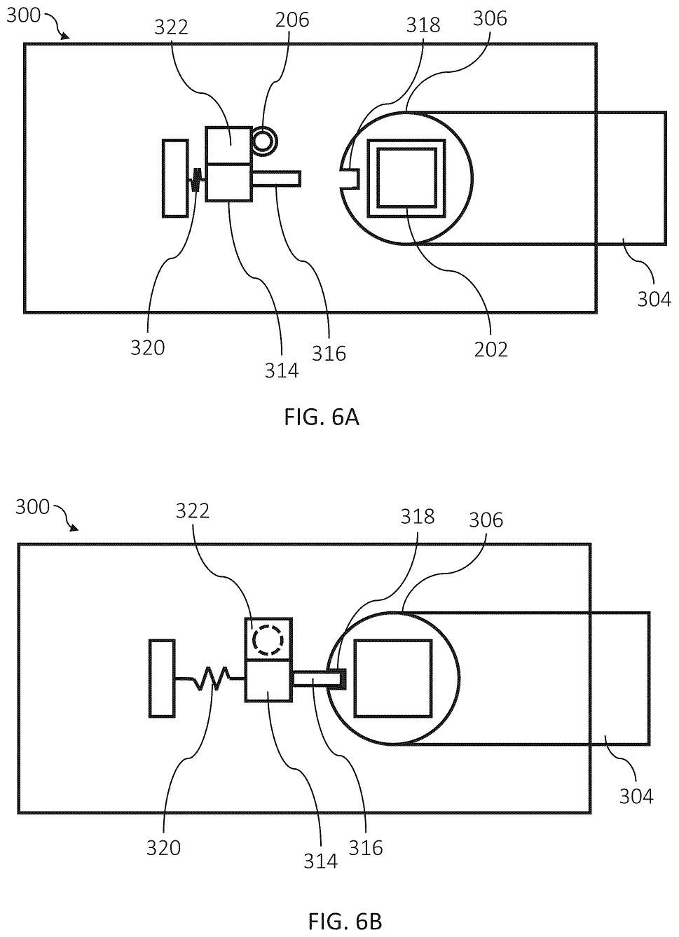

While the above embodiments disclose the cam latch 114 rotating between the disengaged and engaged position, any suitable motion which allow the cam latch to move between engaged and disengaged positions is contemplated. For instance, as seen in FIGS. 6A and 6B, an alternative lock body 300 may include a cam latch 314 configured to slide between a disengaged position (FIG. 6A), and an engaged position (FIG. 6B). Cam latch 314 may include a projection 316 configured to interlock with a slot 318 in the spindle cam 306. Cam latch 314 may be biased to the engaged position via biasing mechanism 320, and projection 206 may contact slanted camming surface 134 to slide the cam latch 314 to the disengaged position. Removing the lock trim assembly 200 from the lock body 300 may remove the projection 206 from the lock body 300, allowing the biasing mechanism 320 to bias the cam latch 314 into the engaged position.

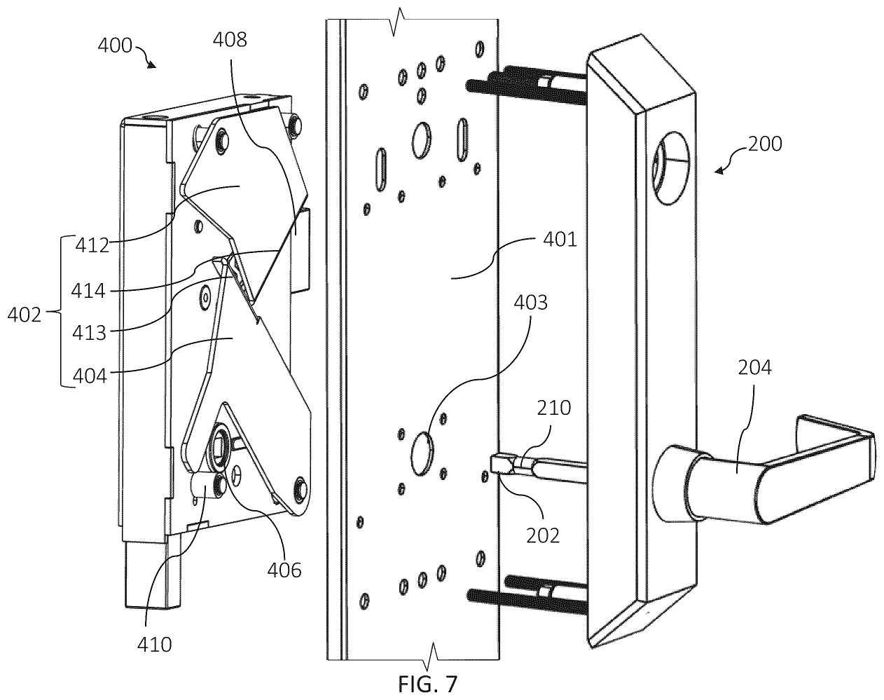

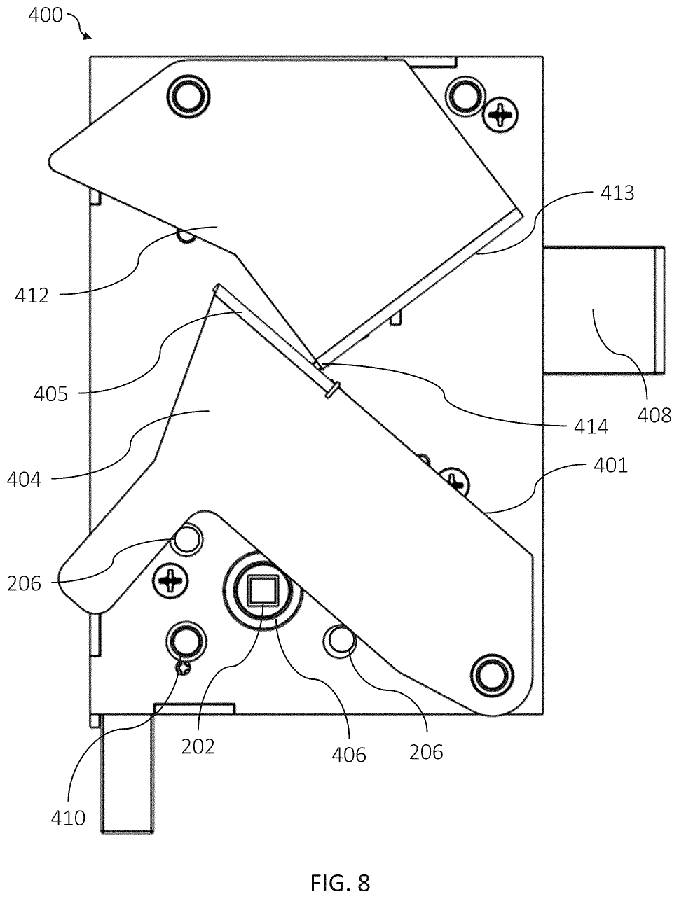

FIG. 7 shows a perspective view of a lock body 400. FIGS. 8-10 show spindle cam shutter assemblies of the lock body 400 at various stages of engagement.

In some embodiments, the inventors have recognized that it may be desirable to prevent an intruder from being able to access the spindle cam in addition to or as an alternative to locking the spindle cam using a cam latch assembly.

In some embodiments, a lock body 400 may include an outer cover 401 and a spindle cam shutter assembly 402. Outer cover 401 may have an opening 403 to allow the lock spindle 202 to be inserted into spindle cam 406, but may prevent any other access to spindle cam shutter assembly 402.

In some embodiments, the spindle cam shutter assembly 402 includes a cover plate 404 configured to move from a disengaged position to an engaged position. When the cover plate 404 is in the disengaged position, as seen in FIG. 8, the spindle cam 406 is not blocked by the cover plate 404. This allows lock spindle 202 to engage with the spindle cam 406 and actuate the deadbolt 408 using one of the deadbolt assemblies discussed above, or any other conventional deadbolt assembly. In some embodiments, cover plate 404 may be held in the disengaged position by projection(s) 206 extending from lock trim assembly 200 into lock body 400. In some embodiments, projection(s) 206 are a support post(s) of the lock trim assembly 200 configured to allow the lock trim assembly 200 to be secured to the door and to a corresponding lock trim assembly on the other side of the door. In some embodiments, projection 206 is a separate projection from the support posts. In some embodiments, the cover plate 404 is held in the disengaged position via contact between the cover plate 404 and a portion 210 of the lock spindle 202. In some embodiments, the portion 210 of the lock spindle includes a rounded cross-sectional profile. Such a configuration may allow the lock spindle 202 to rotate smoothly between engaged and disengaged positions while supporting the cover plate 404 in the disengaged position.

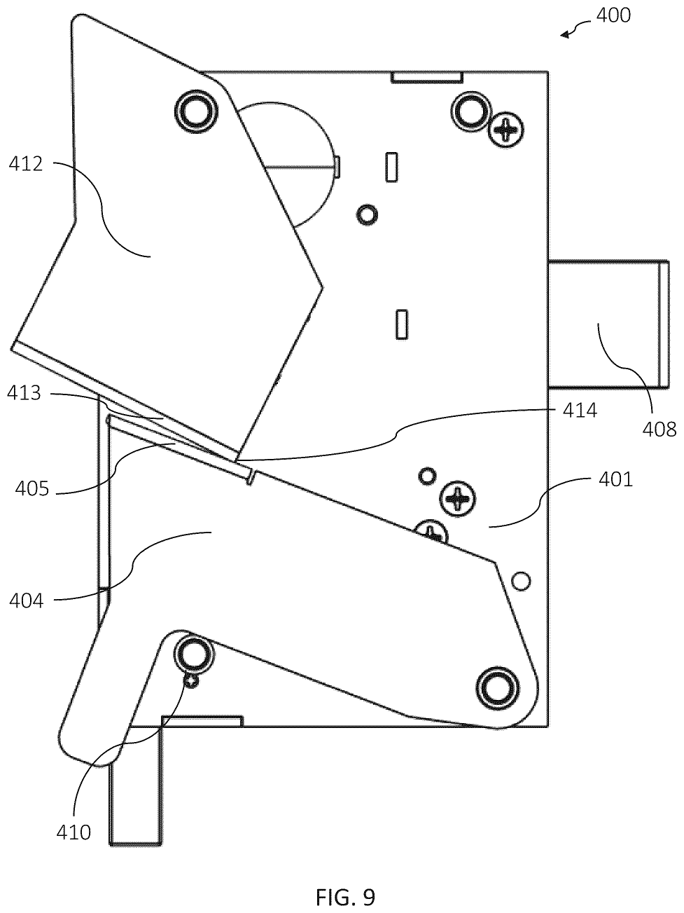

When the lock trim assembly 200 is removed from the lock body 400, the projection(s) 206 and/or lock spindle 202 are removed from the lock body 400 and no longer holds the cover plate 404 in the disengaged position, allowing the cover plate 404 to rotate to the engaged position shown in FIG. 9. In the engaged position, the cover plate 404 blocks access to the spindle cam 406. In some embodiments, a biasing mechanism moves the cover plate 404 to the engaged position. In some embodiments, the cover plates moves to the engaged position via gravity. In some embodiments, the cover plate 404 is supported in the engaged position via support projection 410.

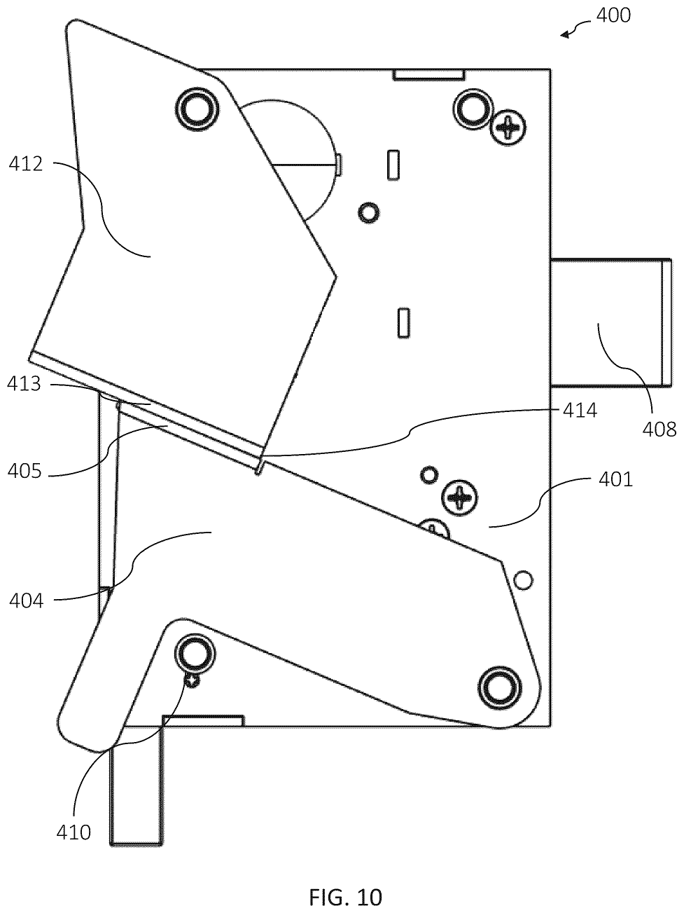

In some embodiments, it may be desirable to block the cover plate 404 in the engaged position to prevent an intruder from jimmying the cover plate 404 to the disengaged position and gaining access to the spindle cam 406. The lock body 400 may include a blocker, such as blocker plate 412 configured to hold the cover plate 404 in the engaged position. As seen in FIG. 9, the blocker plate is supported in the disengaged position via contact between the cover plate 404 and the blocker plate 412. When the cover plate 404 rotates to the engaged position, blocker plate 412 may also be rotated to an engaged position. via a biasing mechanism, gravity, or any other suitable means. If an intruder were to attempt to jimmy the cover plate to disengaged position, as seen in FIG. 10, a surface 413 of blocker plate 412 will contact a surface 405 of cover plate 404, preventing further movement of the cover plate 404 to the disengaged position.

In some embodiments, blocker plate 412 includes a pawl 414 (e.g. a corner of the blocker plate) configured to interlock with teeth (not shown) on the cover plate 404. Engagement between the teeth and the pawl may function like a ratchet, allowing rotation of the cover plate 404 and blocker plate 412 to the engaged positions, while preventing rotation of the cover plate 404 and blocker plate 412 to the disengaged positions via contact between the pawl and the teeth.

While the above embodiments disclose cover plate and blocker plate configured to rotate from the disengaged positions to the engaged positions, either of both of cover plate and blocker plate may be configured to slide from the disengaged positions to the engaged positions. Additionally, the blocker need not be a blocker plate, but may be any suitable mechanism which holds the cover plate in the engaged position.

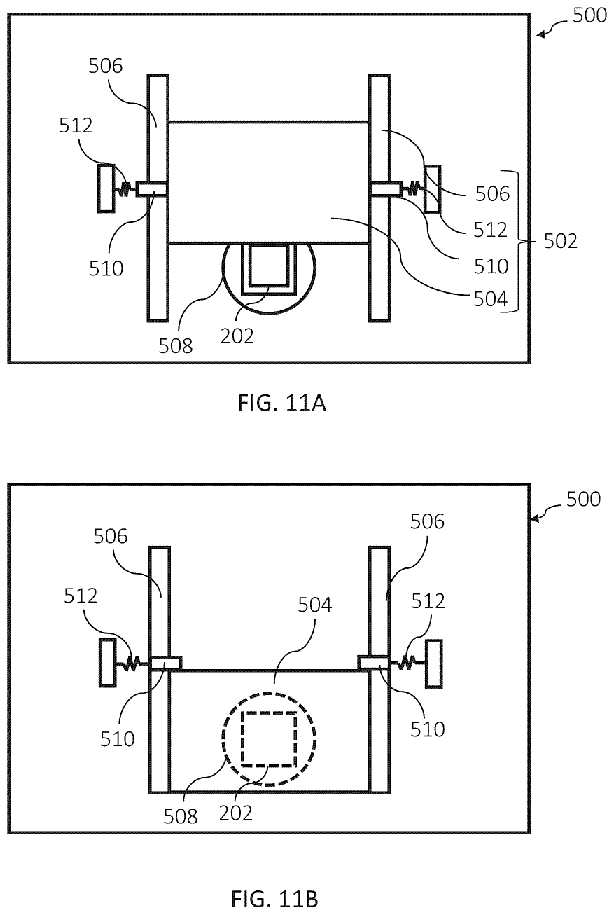

For instance, FIGS. 11A and 11B show schematic representations of an alternative lock body 500 with an alternative spindle cam shutter assembly 502 in disengaged and engaged positions respectively. Cover plate 504 may be configured to slide along rails 506 between the engaged position and disengaged positions. Cover plate 504 may supported in the disengaged position via contact between the cover plate 504 and the lock spindle 202, or via contact between the cover plate 504 and some other projection extending from the lock trim assembly 200. When the lock spindle and/or projection are removed from lock body 500 when lock trim assembly 200 is removed from the lock body 500, the cover plate may slide to the engaged position, as seen in FIG. 11A, and block access to the spindle cam 508. The cover plate 504 may be held in the engaged position via at least one pin 510. Each pin 510 may be biased towards the engaged position via biasing mechanism 512, but held in the disengaged position via contact between the cover plate 504 and a head of each pin 510 when the cover plate is in the disengaged position. When the cover plate 504 moves to the engaged position, the head of each pin no longer contacts the cover plate 504, allowing the biasing mechanism(s) 512 to push the pin(s) to the engaged position. In the engaged position, a side of each pin may prevent the cover plate 504 from moving to the disengaged position via contact between the side of the pin and the cover plate 504.

While the above embodiments disclose lock bodies with deadbolt assemblies, any suitable bolt or latch mechanism configured to be received into pocket(s) of the door jamb is contemplated. For instance, any of the above deadbolt assemblies may be substituted for a latch assembly. Alternatively, a lock body could include a bolt assembly with both a deadbolt and a latch.

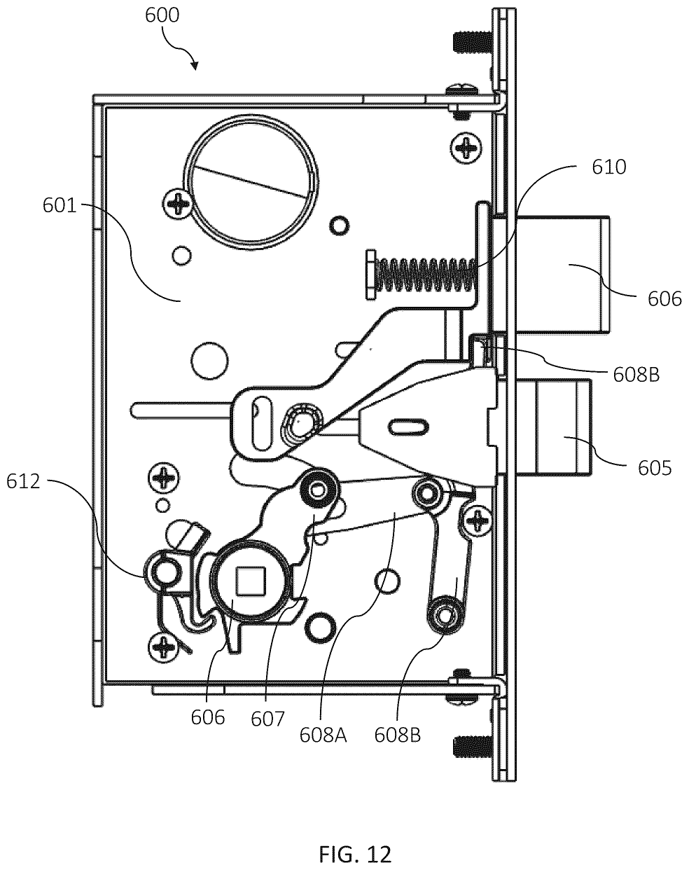

For instance, FIG. 12 shows a side view of lock body 600, with a bolt assembly 602 which includes both a deadbolt 604 and a door latch 605. Both the deadbolt 604 and the door latch 605 may be operatively connected to arm 607 of the spindle cam 606 via transmission unit linkages 608A and 608B, such that rotation of the spindle cam 606 from the engaged position to the disengaged position moves both the deadbolt 604 and the door latch 605 from the engaged positions to the disengaged positions. Spindle cam 606 may be operatively connected to lock spindle 202 and lock trim actuator 204, such that rotation of the lock trim actuator 204 to the disengaged position via an external force (e.g. a user grasping and rotating the lock trim actuator), moves the lock spindle 202 and the spindle cam 606 to the disengaged position.

Once the external force to the lock trim actuator 204 is removed (e.g. when a user lets go of the lock trim actuator), the lock trim actuator 204, lock spindle 202, and door latch 605 may be moved to the engaged positions using any suitable mechanism. For instance, a biasing mechanism (not shown), may be operatively connected any of the lock trim actuator 204, lock spindle 202, door latch 605, spindle cam 606, and transmission unit linkages 608A and 608B, and configured to bias this component to the engaged position. Because all of these components are operatively connected, when the component operatively connected to the biasing mechanism is moved to the engaged position, the rest of these components will also be moved to their respective engaged positions.

In some embodiments, transmission linkage 608B is configured to only push the deadbolt 604 to the disengaged position, such that the deadbolt 604 does not return to the engaged position with the rest of bolt assembly 602. The deadbolt 604 may be held in the disengaged position via a separate trigger mechanism (not shown). Actuation of the trigger mechanism may release the deadbolt and may allow biasing mechanism 610 to bias the deadbolt 604 to the engaged position. The trigger mechanism may be configured to be actuated via contact between the trigger mechanism and a portion of the door jamb. Such a deadbolt assembly is disclosed in U.S. Pat. No. 11,702,864, which is incorporated by reference herein.

Lock body 600 may include a cam latch assembly 612 configured to selectively engage with spindle cam 606 when the lock trim assembly 200 is removed to prevent the deadbolt 604 and the door latch 605 from moving to the disengaged positions when the lock trim assembly 200 is removed. Cam latch assembly 612 may be substantially similar to any of the cam latch assemblies disclosed above.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A lock body comprising:
a bolt assembly comprising a spindle cam configured to engage with a lock spindle of a lock trim assembly, such that rotating the lock spindle about a lock axis rotates the spindle cam about the lock axis; and
a spindle cam latch assembly comprising:
a cam latch configured to move between an engaged position, where the cam latch engages with the bolt assembly to prevent rotation of the spindle cam about the lock axis, and a disengaged position; and
a biasing mechanism configured to bias the cam latch towards the engaged position;
wherein the cam latch is configured to selectively engage with a projection extending from the lock trim assembly, such that when the lock trim assembly is engaged with the lock body, the projection extends into the lock body and moves the cam latch to the disengaged position, and when the lock trim assembly is disengaged from the lock body, the projection is removed from the lock body and the cam latch is moved to the engaged position by the biasing mechanism.

2. The lock body of claim 1, wherein the cam latch rotates between the engaged position and the disengaged position.

3. The lock body of claim 2, wherein the biasing mechanism is a torsion spring.

4. The lock body of claim 2, wherein the cam latch comprises a hook portion configured to engage with a corresponding tab on the spindle cam when the cam latch is in the engaged position.

5. The lock body of claim 2, wherein the cam latch comprises a lever arm configured to contact the projection when the projection extends into the lock body.

6. The lock body of claim 5, wherein the lever arm comprises a camming surface configured to convert a force from the projection into a torque on the cam latch to rotate the cam latch to the disengaged position.

7. The lock body of claim 1, wherein the cam latch is configured to slide between the engaged position and the disengaged position.

8.-11. (canceled)

12. A lock body comprising:
a bolt assembly comprising a spindle cam configured to engage with a lock spindle of a lock trim assembly, such that rotating the lock spindle about a lock axis rotates the spindle cam about the lock axis; and
a spindle cam shutter assembly comprising:
a cover plate configured to move between a cover plate engaged position and a cover plate disengaged position, wherein the cover plate is configured to cover the spindle cam in the cover plate engaged position; and
a blocker configured move between a blocker engaged position and a blocker disengaged position, wherein the blocker is configured to hold the cover plate in the cover plate engaged position when the blocker is in the blocker engaged position;
wherein the cover plate is configured to be held in the cover plate disengaged position by a portion of the lock trim assembly, such that when the lock trim assembly is disengaged from the lock body, the cover plate moves to the cover plate engaged position.

13. The lock body of claim 12, wherein the cover plate is configured to be held in the cover plate disengaged position by the lock spindle of the lock trim assembly.

14. The lock body of claim 12, wherein the cover plate is configured to be held in the cover plate disengaged position by a projection separate from the lock spindle.

15. The lock body of claim 12, wherein the cover plate is configured to be moved to the cover plate engaged position via gravity.

16. The lock body of claim 12, wherein the cover plate is configured to rotate between the cover plate disengaged position and the cover plate engaged position.

17. The lock body of claim 16, further comprising a torsion spring configured to bias the cover plate to the cover plate engaged position.

18. The lock body of claim 12, wherein the blocker comprises a blocker plate.

19. The lock body of claim 18, wherein the cover plate is configured to rotate between the cover plate disengaged position and the cover plate engaged position, and wherein the blocker plate is configured to rotate between the blocker disengaged position and the blocker engaged position.

20. The lock body of claim 19, wherein the blocker plate is configured to bind against the cover plate when the cover plate and the blocker plate are in respective engaged positions and prevent rotation of the cover plate to the cover plate disengaged position.

21. The lock body of claim 12, wherein the blocker comprises a pin, wherein the pin is configured to be retracted in the blocker disengaged position and extended via a biasing mechanism in the blocker engaged position; wherein the pin is configured to engage with a side of the cover plate in the blocker engaged position to prevent movement of the cover plate to the cover plate disengaged position.

22. A door lock system comprising:
a lock trim assembly comprising a lock spindle configured to rotate about a lock axis; and
a lock body configured to selectively engage with the lock trim assembly, the lock body comprising:
a bolt assembly comprising a spindle cam configured to engage with the lock spindle; such that rotating the lock spindle about the lock axis rotates the spindle cam about the lock axis; and
a spindle cam shutter assembly comprising:
a cover plate configured move between a cover plate engaged position and a cover plate disengaged position, wherein the cover plate is configured to cover the spindle cam in the cover plate engaged position; and
a blocker configured move between a blocker engaged position and a blocker disengaged position; wherein the blocker is configured to hold the cover plate in the cover plate engaged position when the blocker is in the blocker engaged position;
wherein the cover plate is configured to be held in the cover plate disengaged position by a portion of the lock trim assembly, such that when the lock trim assembly is disengaged from the lock body, the cover plate moves to the cover plate engaged position.

23. The door lock system of claim 22, wherein the cover plate is configured to be held in the cover plate disengaged position by the lock spindle.

24. The door lock system of claim 22, further comprising a projection extending from the lock trim assembly, wherein the projection configured to hold the cover plate in the cover plate disengaged position.

25. The door lock system of claim 24, wherein the projection extend approximately parallel to the lock spindle.

26.-28. (canceled)
